(19) United States
(12) Patent Application Publication
(10) Pub. No.: US 2010/0011586 A1
(43) Pub. Date: Jan. 21, 2010

(54) Hair Trimmers

(76) Inventors: Roy Nicoll, Winnish (GB); Isabelle Jane Adams, Reading (GB); Chirstopher Wattam, London (GB); Ian Anthony Goodhead, Burton on Trent (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/504,014

(22) Filed: Jul. 16, 2009

Related U.S. Application Data
(60) Provisional application No. 61/135,091, filed on Jul. 16, 2008.

(51) Int. Cl. B26B 21/40; B26B 19/00

(52) U.S. Cl. 30/34.1

(57) ABSTRACT

A hair trimming unit has a plastic housing 1 with a contact surface 2 for substantially flat coplanar sliding contact with a hirsute body area. A first blade 6 with a first elongate cutting edge 5 is mounted on a blade platform 4 formed on the housing so that the blade is forwardly inclined towards the contact surface and the blade edge 5 is at a set height above the contact surface. A connection member 10 is joined to the housing 1 where the member pivots about a pivot axis that is disposed at a point that is between about 10% and 70% of the trimming width as measured from the rear wall. A series of forwardly projecting elements 3 on the housing extend over the blade edge on the side of the contact surface and provide a comb structure for separating hair and guiding the hairs into contact with the exposed blade edge sections between the elements 3.

### CROSS REFERENCE TO RELATED APPLICATIONS

This application claims the benefit of U.S. Provisional Application No. 61/135,095, filed Jul. 16, 2008.

### FIELD OF THE INVENTION

This invention relates to hair trimmers, and more particularly to a hair trimming unit for trimming hair to a given length.

### BACKGROUND OF THE INVENTION

Various forms of hair trimming devices have been proposed in the past. Whereas a razor is generally designed to remove all hair by cutting hairs as close as possible to the skin from which they protrude, hair trimmers are adapted for shortening the length of hairs while still leaving a desired length extending from the skin. Prior art hair trimmers include electric trimming devices with blades or foils which are driven to sever hairs with a shearing action, comb-like devices incorporating blades to cut hairs in the course of combing hair, and scissors. Many of the manual devices require considerable skill to obtain an even cutting of hairs to uniform length. Therefore there remains a need for a hair trimming device that is of simple construction, convenient to use, and able to trim hairs effectively to a generally uniform given length. It is the object of this invention to provide such a device.

### SUMMARY OF THE INVENTION

With the foregoing object in mind, in accordance with the present invention there is provided a hair trimming unit for trimming body hair to a given length, comprising: a plastic housing having a contact surface for substantially flat coplanar sliding contact with a hirsute body area, and having a series of parallel elements projecting forwardly at a front part of the housing; a first blade having a first elongate cutting edge, and being mounted within the housing with the first cutting edge facing forwardly and at a distance from the contact surface, the blade being forwardly inclined towards the contact surface; and a connection member joined to the housing where such structure pivots about a pivot axis; wherein the projecting elements extending over the cutting edge on the side of the contact surface, and spaces formed between the projecting elements being open for hairs to pass between the elements to be engaged and cut by the cutting edge as the trimming unit is moved forwardly over the hirsute body area with the contact surface in sliding contact therewith; and wherein a trimming width extends from the first cutting edge to a rear wall of the housing and wherein the pivot axis is disposed at a point that is between about 10% and about 70% of the trimming width as measured from the rear wall.

The trimming unit of the invention may be assembled from few parts. It has a plastic housing on which the blade is mounted and which guides the blade over a hirsute body area in the course of trimming the hairs of this body area. The housing defines a contact surface which has a generally planar face for resting flat against and sliding over the hirsute body area in an essentially coplanar sliding contact so that the blade is maintained at a substantially constant distance or height from the level of the skin of the body area over which the housing slides, and is retained in a set orientation with respect to the skin surface. This blade orientation is forwardly inclined towards the contact surface, which helps ensure comfort in use of the trimming unit by reducing tendency for hairs to be pulled on engagement by the cutting edge of the blade. The forwardly projecting parallel elements function like the tines of a comb to separate hairs and thereby assist in guiding the hairs for engagement by the cutting edge of the blade as the hair trimming unit slides forwardly over the hirsute body area.

Although more than one blade could be included in the hair trimming unit, a single blade is preferred to avoid risk of hairs being engaged simultaneously by several blades in the course of being cut, which can be a cause of significant discomfort. The positioning of the blade edge at a distance of at least 0.5 mm, and preferably at 1.0 mm to 8.0 mm from the contact surface has been found to produce effective trimming results and to be suitable for most body areas and users.

The projecting elements of the housing are preferably uniformly spaced apart along the housing in the direction of the cutting edge. These elements can define the contact surface at least in part. In one preferred construction the projecting elements have bulbous tips at their free forward ends. To facilitate accurate location of the blade, shoulders may be formed on the projecting elements for the sharpened cutting edge of the blade to rest against. A suitable number of projecting elements is from 5 to 20, in particular 8 to 15, for effective hair trimming performance in combination with comfort and safety.

In some embodiments the housing has a generally forwardly directed face that extends from the contact surface of the housing towards the blade. It is possible for the projecting elements to comprise ridges extending over this face and preferably beyond the cutting edge in the direction away from the contact surface. The forwardly directed face can also have a curvature, preferably a concave curvature which may assist with guiding hair to stand up in front of the blade. Also, the elements can be undercut, for example arrowhead-shaped in cross section, to help position hairs as they are cut by the blade.

The angle of inclination of the blade can be 5° to 40°. An inclination in the range of 10° to 35° has been found effective. The housing is conveniently formed with a platform on which the blade sits to be secured in a stable fixed position relative to the housing. The housing can carry one or more lubricating strips, as commonly provided on safety razor cartridges, at the contact surface. The released lubricant can facilitate the movement of the trimming unit over the body in the performance of a trimming stroke. For added comfort, the end regions of the housing which are located beyond the ends of the blade can have smoothly rounded profiles whereby abrupt edges and corners are avoided.

Most conveniently the hair trimming unit is mounted or mountable to the end of a generally elongate handle which extends in a lengthwise direction transversely to the plane of the contact surface of the housing. The lengthwise axis of the handle lies in a plane perpendicular to the length of the cutting edge of the blade. A structure may be provided for connecting the trimming unit to a handle, for example detachably so that the trimming unit can be replaced when its blade has become dulled. The connection member can provide a pivotal connection between the handle and the trimming unit. For this purpose the trimming unit housing includes a connection member, such as a shell bearing or other pivot arrangement, located behind the blade. A connection structure to provide a pivotal connection forward of the blade is also possible.

In one embodiment the hair trimming unit is designed as a unit adapted to be disposed on a safety razor cartridge. The hair trimming unit can be fixedly attached to the safety razor cartridge so that the safety razor can be used for normal shaving when held in one orientation and can be used for hair trimming when held in another, reverse orientation.

### BRIEF DESCRIPTION OF THE DRAWINGS

A more complete understanding of the invention, its objects and features will be gained from the following detailed description of some embodiments, reference being made to the accompany drawings in which:

FIG. 1 is an underneath plan of a first embodiment of a hair trimming unit according to the invention;

FIG. 2 is a top plan of the hair trimming unit shown in FIG. 1;

FIG. 3 is a cross-section through the hair trimming unit of FIG. 1 with the handle connecting member omitted;

FIG. 4 is an isometric view of the hair trimming unit of FIG. 1 shown from the front and above;

FIG. 5 is an isometric view showing the hair trimming unit of FIG. 1 from the rear;

FIG. 6 shows the hair trimming unit of FIGS. 1 to 5 mounted to a handle;

FIGS. 7 to 11 are views corresponding to FIGS. 1 to 5, respectively, showing a second embodiment of a hair trimming unit according to the invention;

FIGS. 12 to 16 are views corresponding to FIGS. 1 to 5, respectively, showing a third hair trimming unit embodying the invention;

FIGS. 17 to 21 are views corresponding to FIGS. 1 to 5, respectively, showing a fourth embodiment of a hair trimming unit;

FIGS. 22 to 26 are views corresponding to FIGS. 1 to 5, respectively, illustrating a fifth embodiment of a hair trimming unit;

FIGS. 27 to 31 are views corresponding to FIGS. 1 to 5, respectively, illustrating a sixth hair trimming unit according to the invention;

FIG. 32 is an underneath rear perspective view of another hair trimming unit according to the invention;

FIG. 33 is a cross-section showing the hair trimming unit of FIG. 32 mounted on to a shaving cartridge;

FIG. 34 shows the assembled shaving cartridge and hair trimming unit of FIG. 33 in perspective;

FIG. 35 is a front elevation of a body grooming device equipped with a hair trimming unit according to the invention;

FIG. 36 is a side elevation of the body grooming device of FIG. 35;

FIGS. 37 and 38 are bottom and top plan views respectively of the body grooming device of FIGS. 35 and 36;

FIG. 39 is an enlarged side elevation of the hair trimming unit of the body grooming device of FIGS. 35 to 38;

FIG. 40 shows in perspective a further hair trimming unit embodying the invention;

FIG. 41 is a perspective view of yet another hair trimming unit embodying the invention;

FIG. 42 shows in perspective a still further embodiment of the invention; and

FIGS. 43A and 43B are views illustrating a modification of the hair trimming unit of FIG. 42.

### DETAILED DESCRIPTION OF THE INVENTION

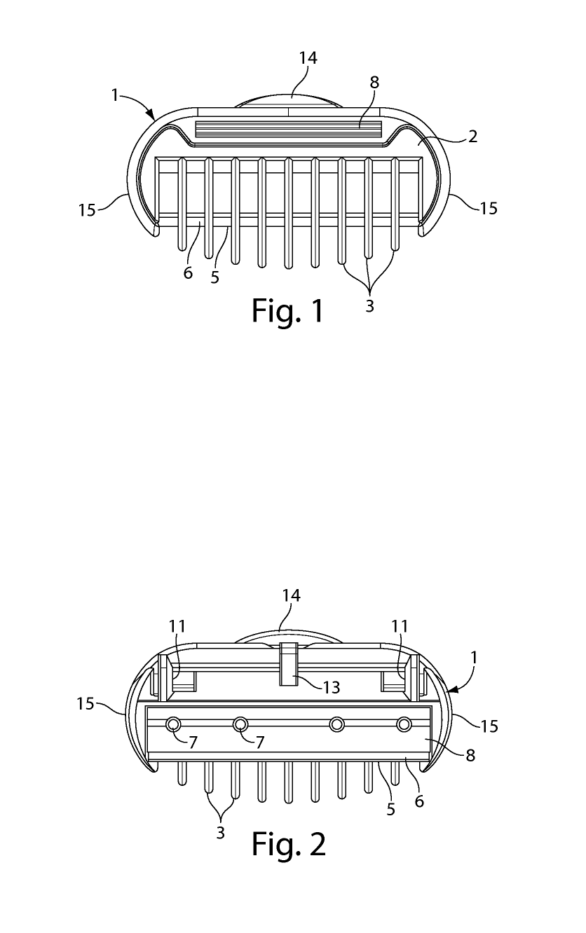

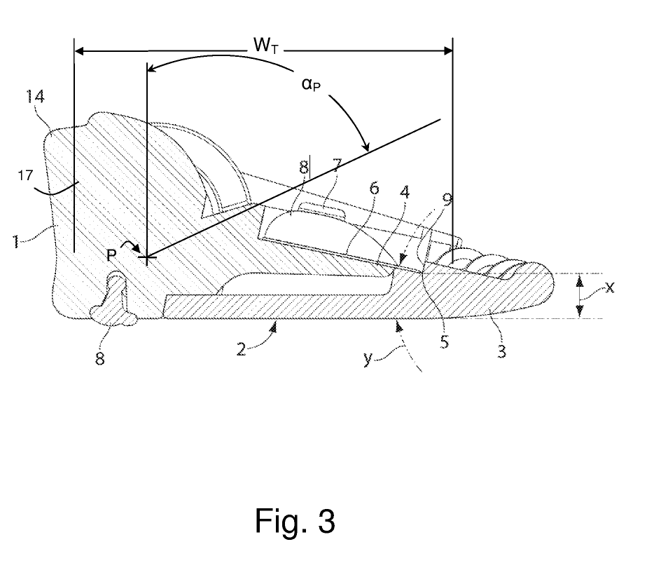

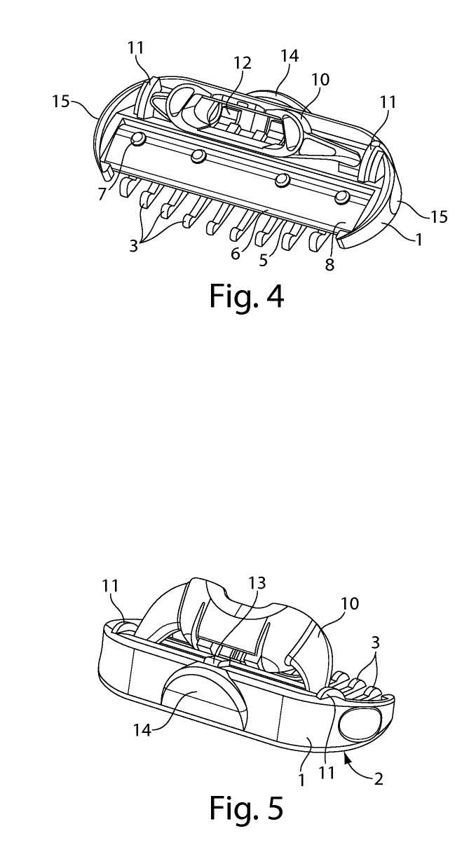

Several embodiments of hair trimming units according to the invention are shown in the drawings, and the same reference numerals are used in all the Figures to designate corresponding components and features. Illustrated in FIGS. 1 to 6 is a hair trimming unit having a plastic housing 1 forming a frame and defining a substantially planar contact surface 2 on the underside for substantially coplanar sliding contact with a hirsute body area having hairs to be trimmed to a given length. For the purposes of the present specification the surface that is intended to contact the body is referred to as the base, bottom or underside, the side opposite the contact face is referred to as the top or upper side, the front is the direction towards which the trimming unit is moved forwardly in the course of trimming hairs, and the rear is opposite the front. However, it will be understood that the trimming unit will be held in different attitudes in use depending on the area of the body having hairs to be trimmed and the posture of the person using the hair trimming device. The plastic housing 1 has a series of parallel elements 3 which project forwardly at the front of the housing, there being nine such elements in the embodiment illustrated. These projecting elements 3 form the tines of a comb structure formed at the front of the plastic housing forwardly of a blade platform 4 on which a flat blade 6 with a straight first cutting edge 5 is mounted and held fixed in position thereon. The comb elements 3 pass over the first cutting edge 5 on the underside thereof, and the comb structure serves to define a forward extension of the contact surface 2. A connection member 10 is joined to the housing where it pivots about a pivot axis P. The pivot axis P is disposed at a point that is between about 10% and about 70% of a trimming width as measured from the rear wall. In one embodiment, the pivot axis is rearward of a midpoint of the trimming width. The pivot axis P has a pivot range or angle of α_{P}. The pivot range may range from 10° to 85° for the various embodiments disclosed herein. The blade is held against the blade platform 4 by a clamping bar 8 which is secured to pins 7 which project from the blade platform 4 through holes in the blade. The cutting edge 5 of the blade 6 overhangs the front edge of the platform 4, for example by about 1.0 to 1.5 mm, for engaging and cutting hairs that enter the spaces between the comb elements 3 as the trimming unit slides over a hirsute body area for the hairs to be trimmed by being severed by the blade 6. The blade 6 is mounted to the blade platform 4 with the cutting edge 5 at a height ‘x’ of about 2.0 mm above the plane of the contact surface 2, and with the blade inclined forwardly and downwardly towards the plane of the contact surface at an angle ‘y’ of 10° to 15°, e.g. about 12°. As used herein, the trimming width WT is defined by the distance from the first cutting edge 5 to a rear wall 17 of the housing 1. The upper edges of the comb elements 3 are stepped to form rearwardly directed shoulders 9 against which the cutting edge of the blade is positioned. As shown, the projecting elements 3 are extended rearwardly along the contact surface 2 so that at least a forward portion of this surface has a series of parallel ridges with grooves therebetween. At a region of the contact surface 2 towards the rear, and spaced rearwardly from the elements 3 is a lubricating strip 8 of a form well known in connection with safety razor cartridges.

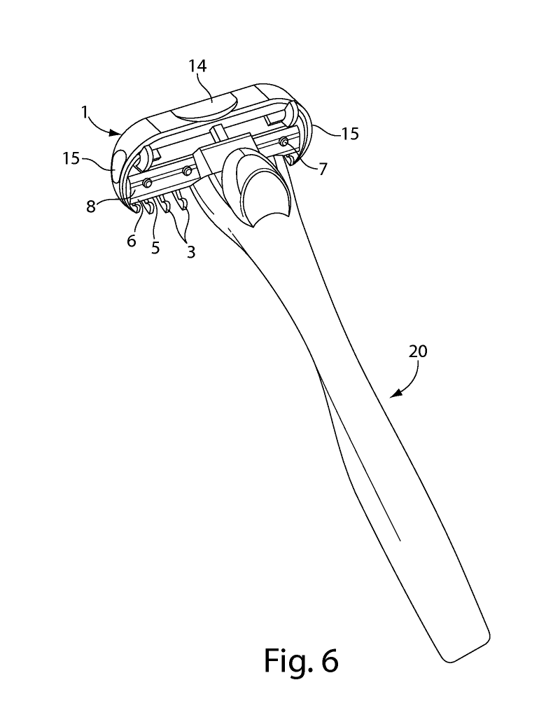

The hair trimming unit is adapted to be mounted to an elongate handle 20 (FIG. 6) and for this purpose is fitted with a connection member 10 in the form of a yoke with two arms extending from a hub. The connection member 10 rotates about a pivot axis P, which is disposed at a point that is between about 10%, 12%, 15% 20%, 25%, 30%, or 35% and about 25%, 30%, 35%, 40%, 65%, 70% of the trimming width WT as measured from the rear wall 17. In this and certain other embodiments disclosed herein, the pivot axis P is disposed at a point that is rearward of the midpoint of the trimming width WT as measured from the rear wall 17. As used herein, “rearward of the midpoint” refers to the pivot axis being disposed at a point that is between 0% and 49% of the trimming width from the rear wall 17. The free ends of the two arms are journaled in pivot sockets 11 formed on the plastic housing 1 above and behind the blade platform 4. The yoke defines a socket 12 for interconnection with the handle 20 (FIG. 6) and may be of the same form as that of the safety razor described in U.S. Pat. Nos. 6,192,586B1; 5,784,790A; 5,813,293A; 5,855,071A; 5,956,851A; 5,787,586A; 5,815,924A; 5,890,296A; 6,029,354A; 6,052,903A; 6,085,426A; 5,822,869A; 5,918,369A; 6,041,926A; and 6,237,232B1. A spring loaded plunger of the handle protrudes through an opening in the yoke of member 10 and acts on a cam follower face 13 formed on the plastic housing 1 to urge the trimming unit to a rest position relative to the handle. From this rest position the trimming unit is able to pivot against the spring loading of the plunger through an angle of 30° to 45°, e.g. about 38°, to follow body contours in the completion of a hair trimming stroke. In the rest position the axis of the handle, which lies in a plane perpendicular to the pivot axis and the length of the blade edge 5, can be at an angle, of from 20° to 50°, preferably 30° to 40°, to the plane of the contact surface 2.

The rear of the plastic housing 1 is configured with a finger pad 14 against which a finger of the user can be applied for pivoting the trimming unit to open up the upper side with respect to the handle to facilitate the removal of cut hairs that may collect on the trimming unit above the blade 6.

As shown in the drawings the ends 15 of the plastic housing 1 disposed beyond the ends of the blade 6 have a rounded configuration as viewed in plan and this smooth convex curvature is continued along the front edge defined by the free ends of the comb elements 3. The elements 3 have bulbous tips, as seen in side elevation, and the lower surfaces are slightly upwardly inclined towards the forward extremities of the elements to help avoid any tendency for the elements to dig into the skin as the trimming unit slides forwardly over the body in the action of trimming hairs.

The described hair trimming unit has a simple construction with few parts yet provides a comfortable and effective hair trimming performance. It can be conveniently used on all body areas where hair trimming may be desired.

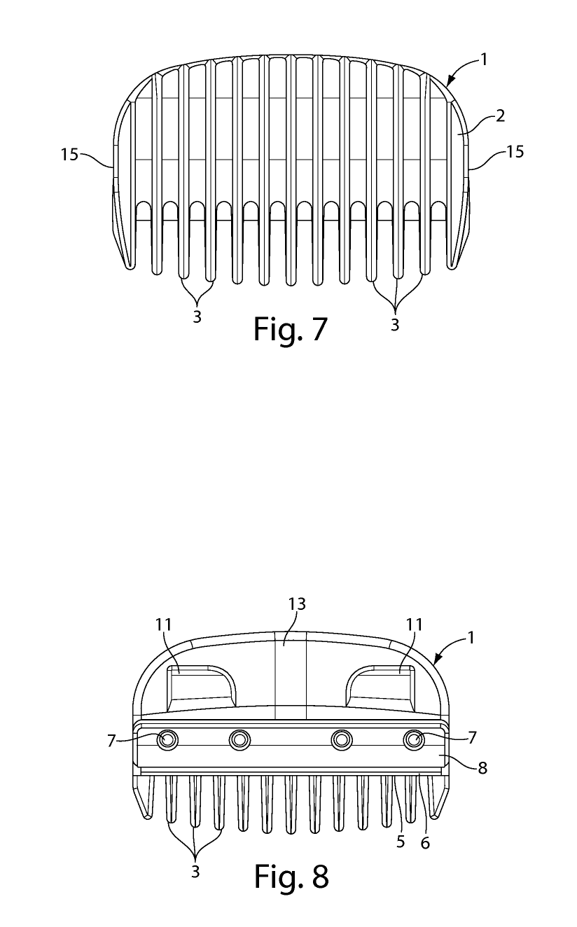

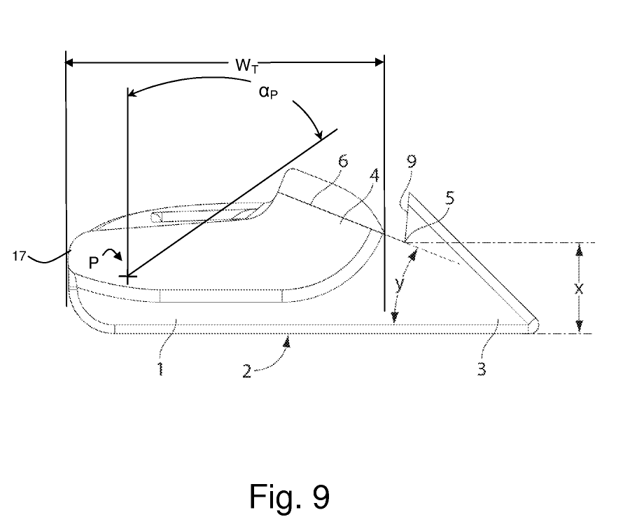

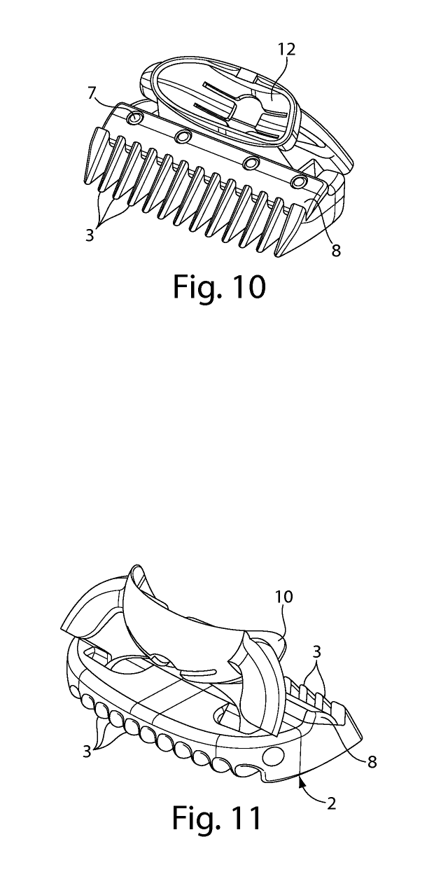

Illustrated in FIGS. 7 to 11 is an alternative embodiment suitable for trimming hairs to a longer length than the hair trimming unit of FIGS. 1 to 5. In this embodiment the plastic housing 1 has a blade platform 4 disposed to mount the blade 6 at an inclination ‘y’ of 15° to 25°, e.g. 20° to 23°, and with the cutting edge 5 of the blade at a height ‘x’ of 4 mm to 6 mm, preferably about 5 mm, above the contact surface 2 defined by the underside of the plastic housing. The trimming width W_{T} is defined by the distance from the first cutting edge 5 to a rear wall 17 of the housing 1. The projecting elements 3 are deep, and have triangular nose portions at their front ends with rearwardly and upwardly inclined top edges which extend substantially above the blade cutting edge 5. In addition the elements 3 extend rearwardly over the entire area of the contact surface 2 whereby this surface is largely formed by the bottom edges of the elements and channels between the elements extend continuously from front to back of the contact surface. In this embodiment there are eleven parallel elements 3 and they are configured to taper in width slightly over their length forwardly of the cutting edge 5 of the blade 6. The curvature at the ends 15 of the trimming unit is less pronounced, than in the case of the first embodiment, as is the curvature followed by the forward tips of the comb elements 3. The hair trimming unit is provided with a handle connecting member 10 generally similar to that of the first embodiment to provide a pivotal connection of the housing 1 of the hair trimming unit to an elongate handle 20. The connection member 10 is joined to the housing 1 where it pivots about pivot axis P.

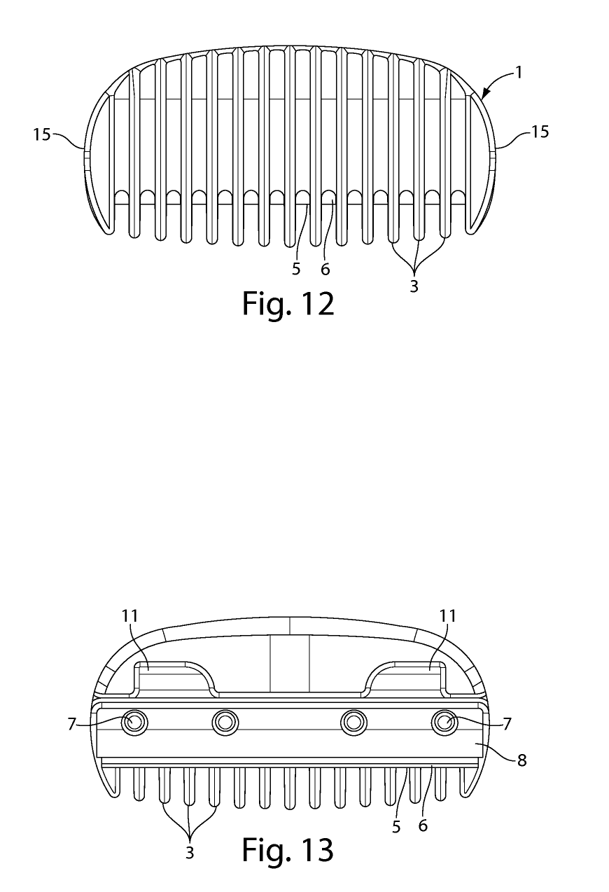

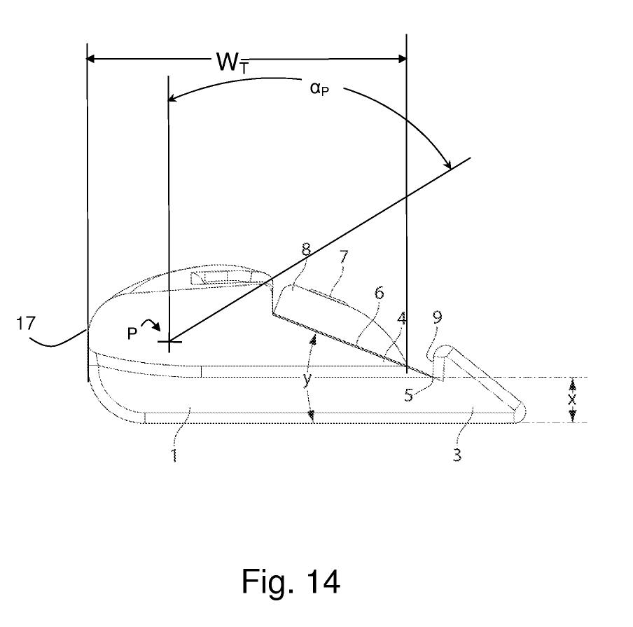

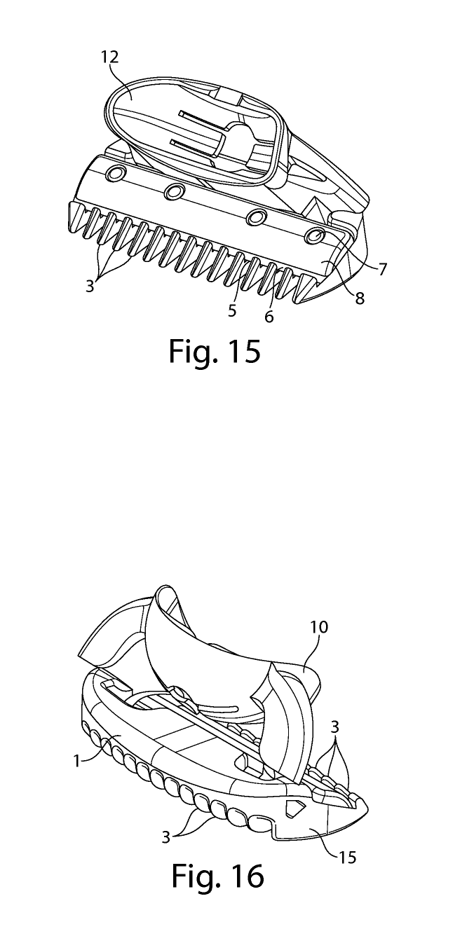

The embodiment of the hair trimming unit illustrated in FIGS. 12 to 16 is basically similar to that of FIGS. 7 to 11, and only the differences need to be explained. The main difference is that the blade platform 4 is arranged to mount the blade 6 with the blade edge 5 at a height of 3 to 4 mm, in particular about 2 mm above the plane of the contact surface 2, but the angle of inclination of the blade is the same at 20° to 23°. In this embodiment there are thirteen comb elements 3, and they are parallel-sided over their entire lengths, but still with rounded edges. As in the previous embodiments a connection member 10 for releasable attachment to a handle 20 is pivotally connected to the plastic housing 1, the pivot axis P being behind and above the cutting edge 5 of the blade 6. The trimming width W_{T} is defined by the distance from the first cutting edge 5 to a rear wall 17 of the housing 1.

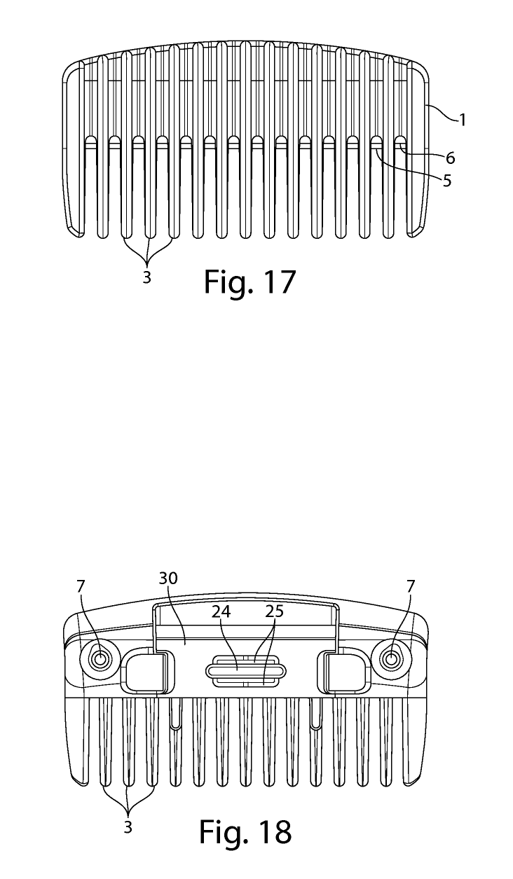

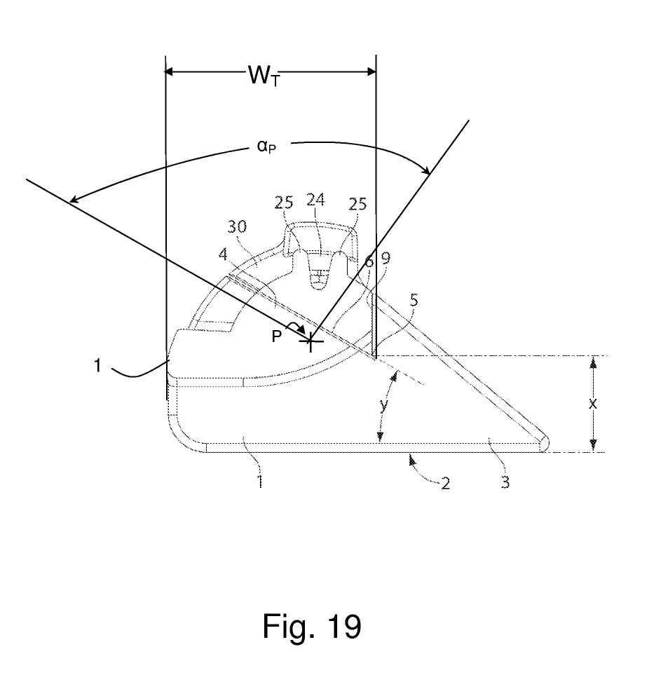

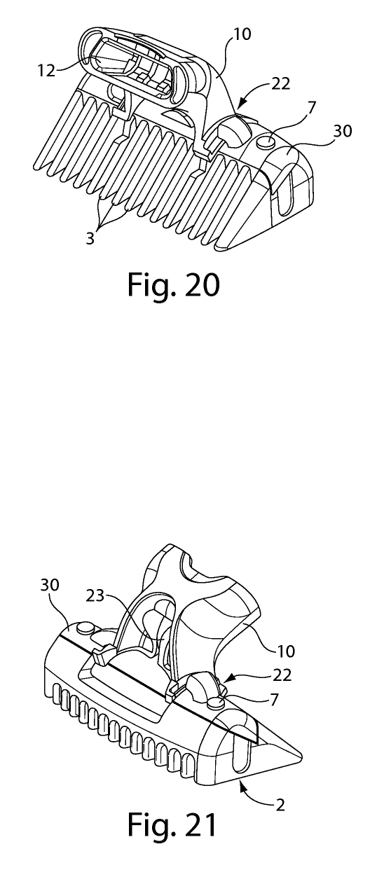

FIGS. 17 to 21 illustrate a further variation of the hair trimming unit of FIGS. 7 to 11. The height ‘x’ of the blade edge 5 above the contact surface 2 is 5 mm and the inclination of the blade 6 are the same. The hair trimming unit has a more rectangular contour as viewed in plan and in particular the front end tips of the forwardly projecting parallel comb elements 3 lie in a straight line parallel to the blade edge 5. The handle connecting member 10 is pivotally attached to the plastic housing by a shell bearing arrangement 22 and a spring finger 23 on the member 10 engages in a groove 24 between a pair of abutments 25 on the rear of the plastic housing so that the hair trimming unit will be biased to a rest position relative to a handle 20 connected to the member 10. With this construction the trimming unit can be pivotable to either side of a medial rest position for added flexibility in following body contours. Also the pivot axis P is a virtual axis and can be located in any desired position, such as close to the plane of the contact surface 2 and either above or below this surface. The trimming width W_{T} is defined by the distance from the first cutting edge 5 to a rear wall 17 of the housing 1. The trimming width may be range from 10 mm, 11 mm, or 12 mm to 13 mm, 14 mm or 15 mm. In this embodiment, the pivot axis P is positioned at a point that is between about 10%, 12%, 15% 20%, 25%, 30%, or 35% and about 25%, 30%, 35%, 40%, 65%, 70% of the trimming width W_{T} as measured from the rear wall 17. In particular, the pivot axis P is at point about 65% of the trimming width W_{T} as measured from the rear wall 17. For convenience of manufacture the shell bearing components of the hair trimming unit are formed on a rear housing part 30 which is fixed onto the main housing part 1 comprising the comb elements 3 and the blade platform 4, and the rear housing part 30 serves to secure the blade 6 on the blade platform so that the need for a separate clamping bar is eliminated. Pins 7 projecting upwardly from the blade platform pass through holes in the blade and the rear housing part for fixing the latter securely in place on the main housing 1.

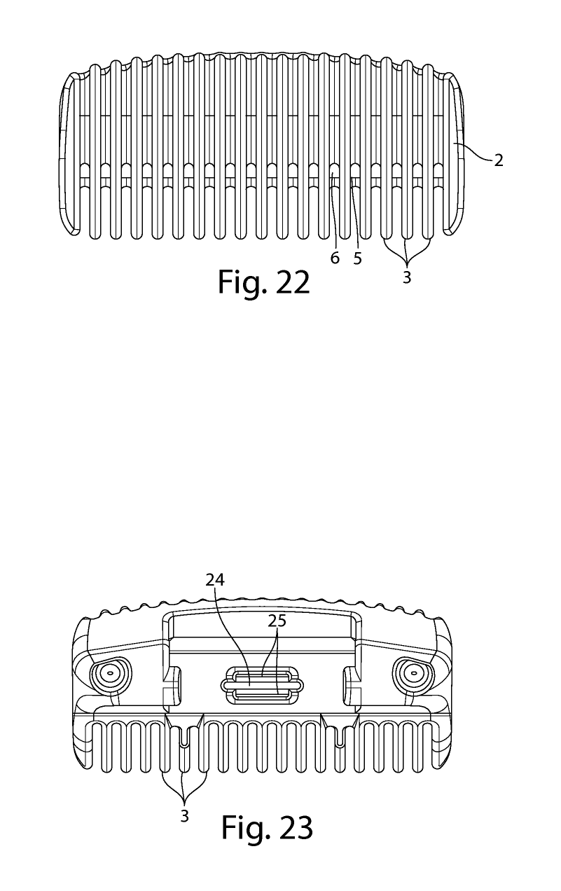

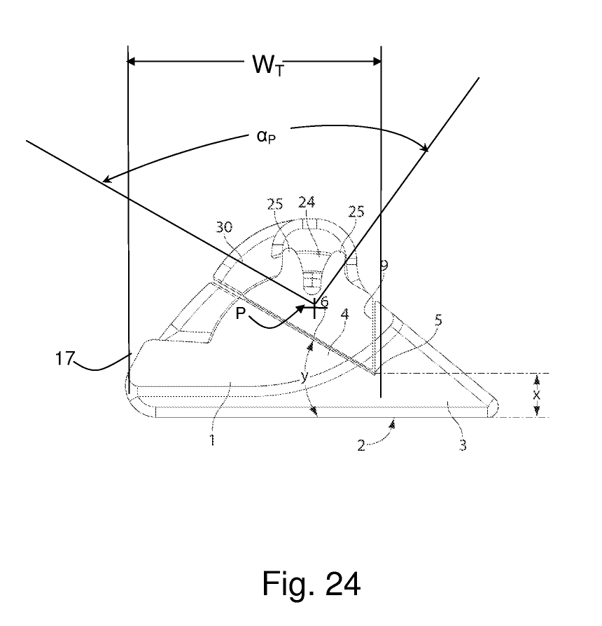

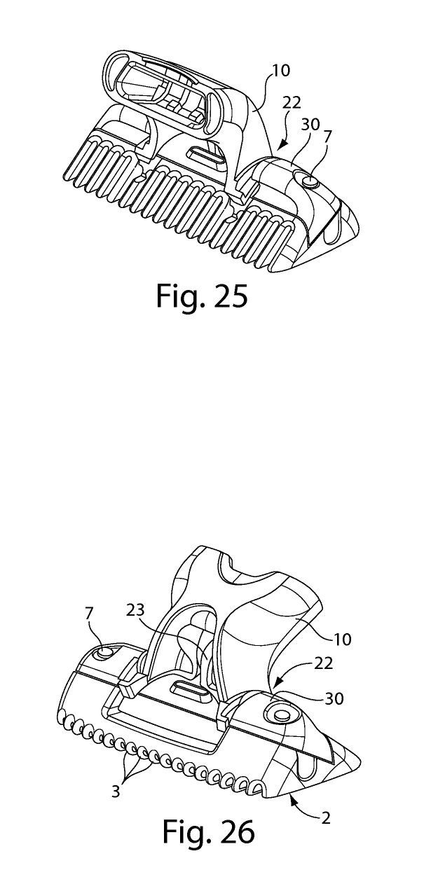

The hair trimming unit of FIGS. 22 to 26 is for the most part the same as that of FIGS. 17 to 21, the main difference being that the blade 6 is mounted with its cutting edge 5 at a lower height ‘x’, in particular 1 mm to 3 mm, preferably about 2 mm above the plane of the contact surface 2. Also, the length of the projecting comb elements 3 forwardly of the blade edge 5 is less.

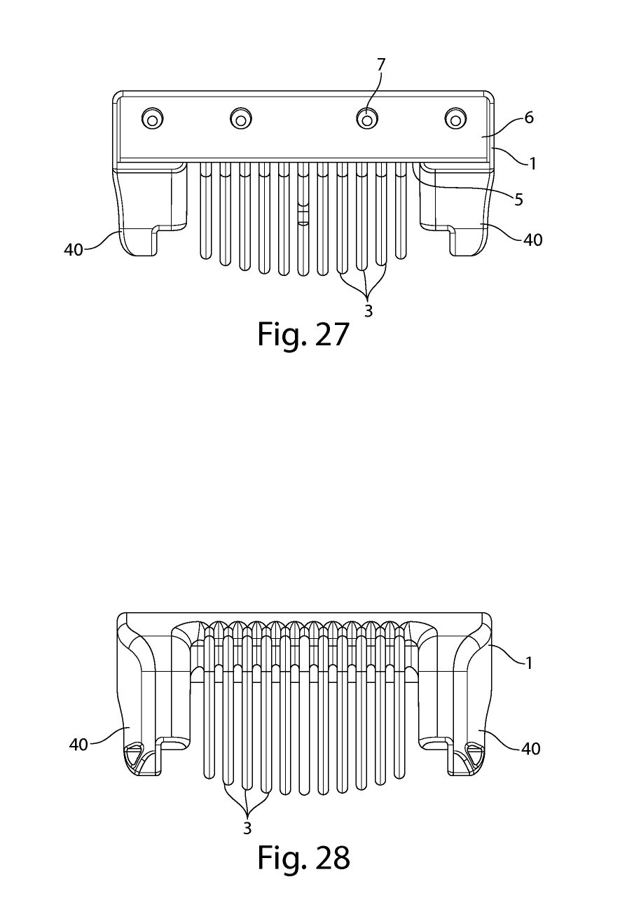

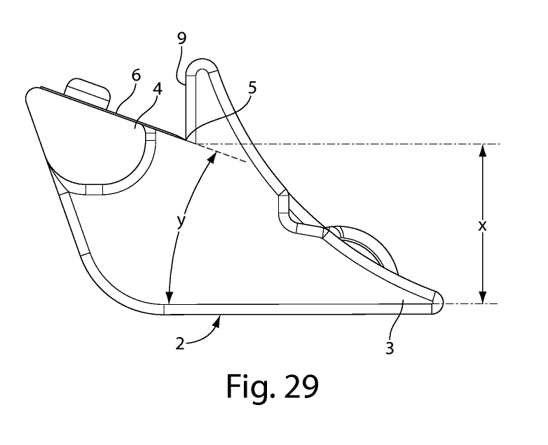

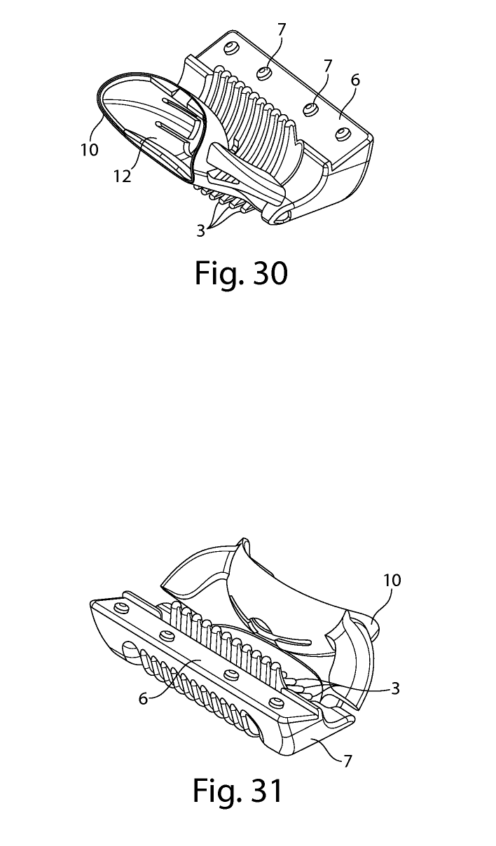

The embodiment of a hair trimming unit shown in FIGS. 27 to 31 has a plastic housing 1 with a series of eleven forwardly projecting parallel comb elements 3, and a blade platform 4 on which a blade 6 is mounted at a forwardly inclined angle ‘y’ of 20°0 to 23°, and with the cutting edge 5 positioned against a shoulder 9 defined by rear edges of the elements 3 and at a height ‘x’ of 4 mm to 6 mm, e.g. about 5 mm above the plane of the contact surface 2. The upper edges of the comb elements sweep rearwardly and upwardly with a slightly concave curvature, and the bottom edges of the elements 3 extend rearwardly over the full front-to-rear extent of the contact surface 2 so that these edges in effect define the contact surface along with forwardly directed side arms 40 of the plastic housing. Adjacent their forward ends the side arms 40 are provided with sockets forming journals for the pivotal connection of the handle connecting member 10. The connecting member is essentially the same as described above with reference to FIGS. 1 to 5. The central comb element has a cam follower face for cooperation with the spring loaded plunger of the handle for biasing the trimming unit to a predetermined rest position when it is connected to a handle 20. In this embodiment the pivot axis P is in front of and below the blade 6 so that the hair trimming unit will be drawn or pulled over the body area by the handle, which may be preferred by some users when trimming hair in certain body areas.

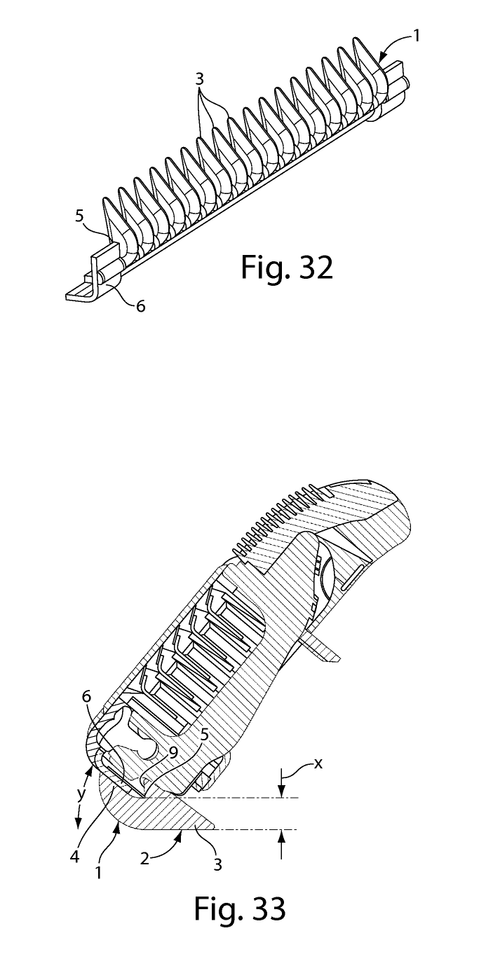

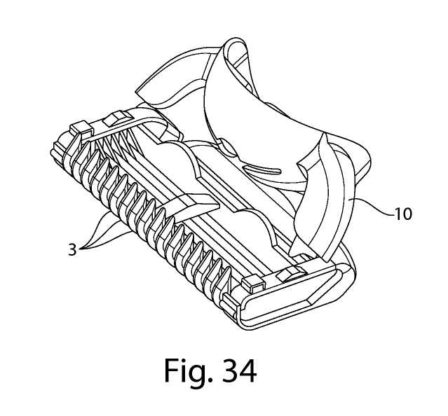

FIGS. 32 to 34 illustrate a hair trimming unit according to the invention designed and configured to be mounted on a shaving cartridge 45. It is previously known to provide a shaving cartridge with an extra blade mounted at the rear of the cartridge for shaving in tight areas such as under the nose. Such a shaving cartridge is described for example in US Patent Publications US 2006/0196054 A1 and US 2008/0172878 A1. In accordance with the present invention a hair trimming unit is mounted to the rear of the cartridge housing rather than the additional shaving blade unit. The hair trimming unit has a plastic housing 1 with a series of several parallel projecting elements 3, thirteen as shown, which have lower edges which combine to form a contact surface 2 of the hair trimming unit for substantially flat coplanar sliding movement over a hirsute body area for trimming hairs in that area. A blade 6 is secured to the plastic housing in a forwardly and downwardly inclined orientation with respect to the contact surface 2, the cutting edge 5 being positioned against a shoulder 9 provided on the comb elements 3 and being at a height of 1 to 3 mm, e.g. around 1.2 mm above the contact surface 2. The blade inclination in this embodiment is 35°0 to 45°, e.g. around 40° to the plane of the contact surface 2. The hair trimming unit can be secured to the shaving cartridge in any convenient manner. For example metal clips may wrap around the ends of the hair trimming unit and portions of the shaving cartridge frame.

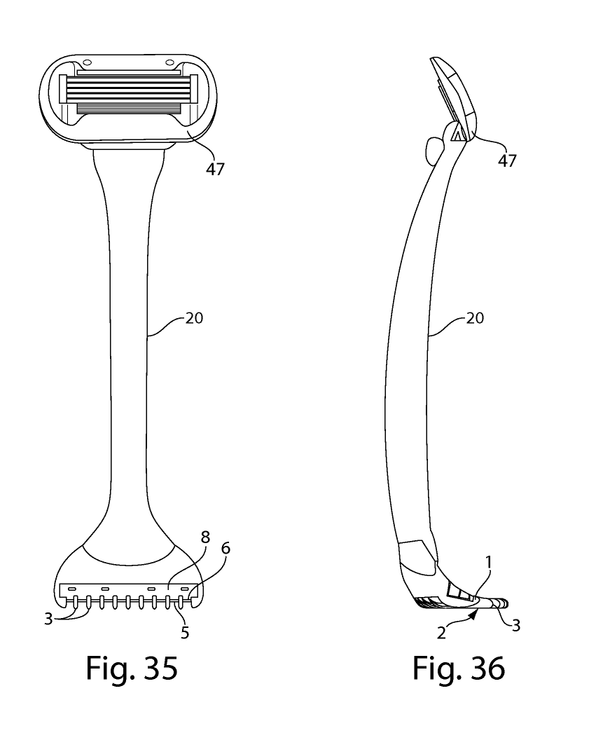

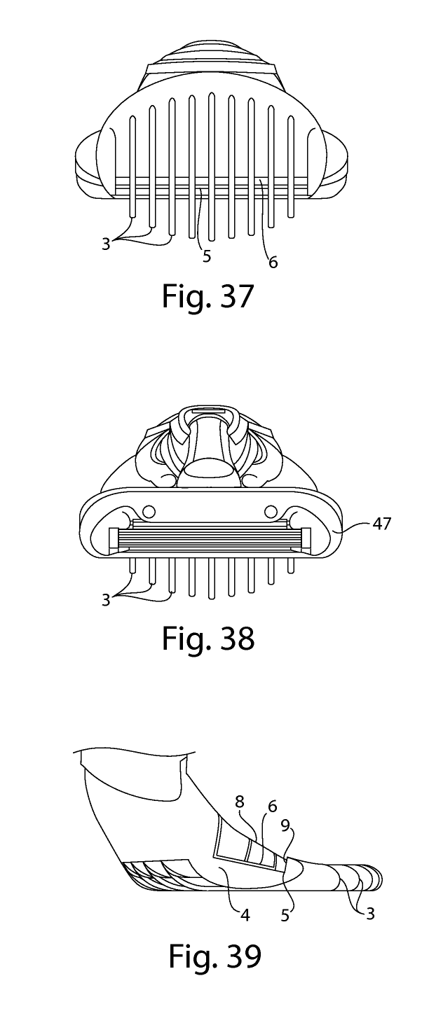

FIGS. 35 to 39 illustrate a body grooming device with a double-ended handle 20 having a conventional shaving cartridge 47 detachably connected at one end of the handle and a hair trimming unit in accordance with the present invention detachably connected to the other end of the handle 20. The hair trimming unit is configured so that the flat contact surface 2 forms a base enabling the device to stand upright on a horizontal support surface as illustrated in FIGS. 35 and 36. The hair trimming unit has a plastic housing 1 with a blade platform 4 mounting a blade 6 with a sharp cutting edge 5 which can be at a height of 1 to 3 mm above the contact surface 2. The blade is forwardly and downwardly inclined at an angle of 10° to 20°, such as about 15°. The forwardly projecting comb elements 3 are extended rearwardly to the rear of the housing 1 and they project under the blade edge 5 to rounded front end tips. When the device is used for hair trimming the contact surface 2 of the hair trimming unit is placed flat against the body area to be treated and the hair trimming unit is moved forward. The comb elements 3 comb and separate the hairs encouraging them to stand up in the spaces between the comb elements to be engaged by the cutting edge 5 of the blade 6 and to be severed at a generally uniform length as the blade advances.

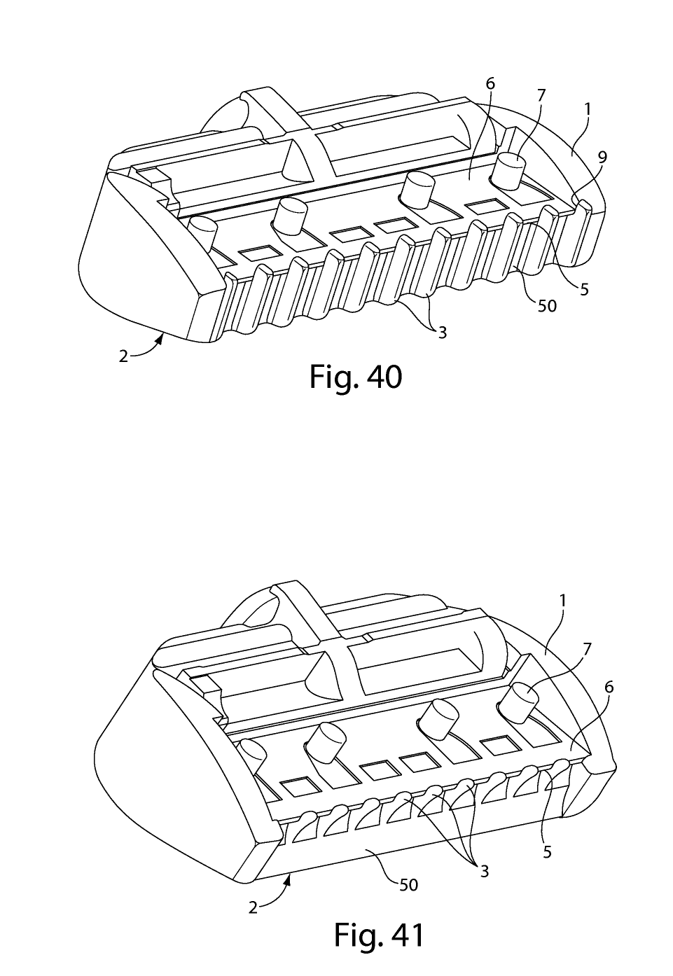

Some further embodiments of hair trimming units are illustrated in FIGS. 40 to 42. As shown in FIG. 40 the plastic housing 1 has a front wall 50 at the leading edge of the blade platform 4 which extends upwardly from the contact surface 2 to the blade platform. A series of spaced projecting elements 3 are provided in the form of parallel ridges extending upwardly over the front wall 50 and terminating above the blade edge 5 which is positioned against shoulders 9 formed on the ridges 3 which extend forwardly over the underside of the blade edge and upwardly.

In the hair trimming unit of FIG. 41, the front wall 50 of the housing 1 is formed with a concave shape to encourage hairs to stand up as they encounter this wall. The projecting elements 3 form a continuation of the curvature as they extend upwardly and beyond the blade edge 5, the elements 3 in this case being confined to an upper portion of the front wall 50.

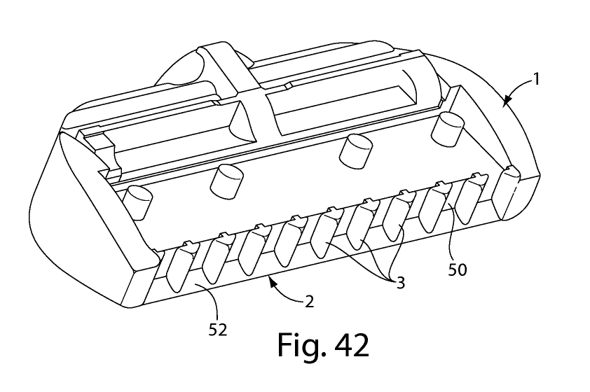

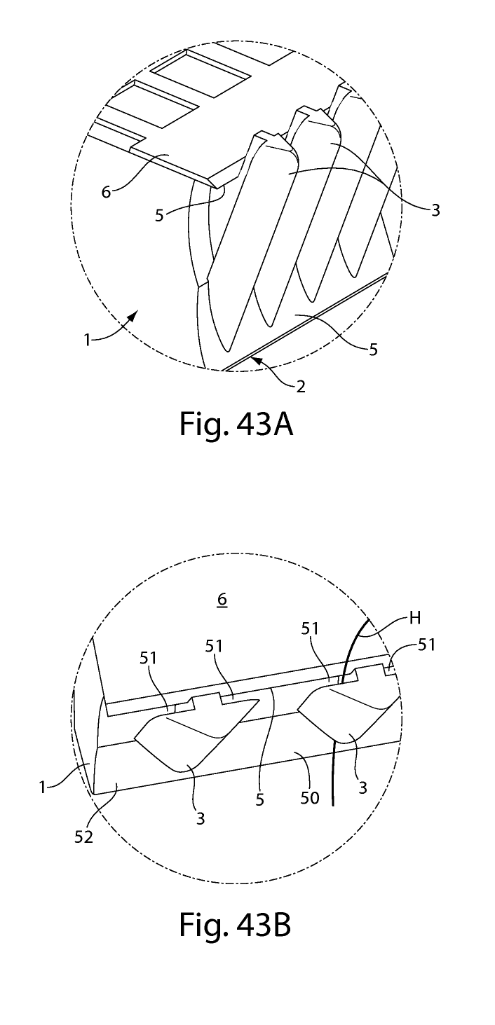

In the hair trimming unit of FIG. 42, the projecting elements 3 extend upwardly over the front wall, but in this case are undercut with an arrow-head shape in cross section. In this way grooves or slots 51 are formed between the front wall 50 and the arrowheads in which hairs H will tend to be held until severed by the cutting edge 5 of the blade, as shown in FIG. 43B. The projecting elements 3 do not extend downwardly as far as the contact surface 2 and instead merge into a rail 52 that extends continuously along the front wall over the full width of the housing 1. Of course elements 3 with arrowhead cross-sections can also be used with a concave front wall as depicted in FIGS. 43a and 43b.

Many modifications are possible to the described embodiments without departing from the scope of the invention as defined in the claims which follow. Although in the interest of simplicity the hair trimming units specifically disclosed have blades secured in a fixed position relative to the contact surface of the housing, constructions in which the blade 6 is adjustable in position to vary the height of the cutting edge 5 above the contact surface 2 and/or to vary the inclination of the blade relative to the contact surface of the housing 1 can be easily envisaged. In addition, although it is preferred for the hair trimming unit to be pivotable relative to the handle 20 on which it is carried in use, a fixed attachment of the trimming unit to the handle is also possible.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While in particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A hair trimming unit for trimming body hair to a given length, comprising:
a. a plastic housing having a contact surface for substantially flat coplanar sliding contact with a hirsute body area;
b. a series of parallel elements projecting forwardly at a front part of the housing;
c. a first blade having a first elongate cutting edge, and being mounted within the housing with the first cutting edge facing forwardly and at a distance from the contact surface, the blade being forwardly inclined toward the contact surface; and
d. a connection member joined to the housing where such structure pivots about a pivot axis;
wherein the projecting elements extend over the cutting edge on a the contact surface, and spaces form between the projecting elements that are open for hairs to pass between the elements to be engaged and cut by the first cutting edge as the trimming unit is moved forwardly over body hair with the contact surface in sliding contact therewith; and
wherein a trimming width extends from the first cutting edge to a rear wall of the housing and wherein the pivot axis is disposed at a point that is between about 10% and about 70% of the trimming width as measured from the rear wall.

2. A hair trimming unit according to claim 1 wherein the pivot axis is disposed at a point that is between about 10% to about 40% of the trimming width from the rear wall.

3. A hair trimming unit according to claim 1, wherein the blade is mounted with the cutting edge at a distance of at least about 0.5 mm from the contact surface.

4. A hair trimming unit according to claim 2, wherein the cutting edge is at a distance of 1.0 to 8.0 mm from the contact surface.

5. A hair trimming unit according to claim 1, wherein the contact surface is at least partially formed by the projecting elements.

6. A hair trimming unit according to claim 1, wherein the elements have bulbous free end portions enlarged in the direction away from the contact surface and disposed forwardly of the cutting edge.

7. A hair trimming unit according to claim 1, wherein the elements have shoulders against which the cutting edge is positioned.

8. A hair trimming unit according to claim 1 wherein the pivot axis is disposed at a point about 65% of the trimming width as measured from the rear wall.

9. A hair trimming unit according to claim 1, wherein the projecting elements are uniformly spaced apart over the length of the blade.

10. A hair trimming unit according to claim 1, wherein the housing has a front wall extending upwardly towards the blade, and the elements comprise ridges extending over the front wall and beyond the cutting edge.

11. A hair trimming unit according to claim 1 wherein the connection member comprises a shell bearing connector.

12. A hair trimming unit according to claim 1 wherein the connection member comprises a hood connector.

13. A hair trimming unit according to claim 1, wherein the blade is inclined to the contact surface at an angle of 5° to 40°.

14. A hair trimming unit according to claim 1 wherein the projecting elements have a height of from 10 mm to about 15 mm.

15. A hair trimming unit according to claim 1, wherein the housing carries one or more lubricating strips exposed at the contact surface.

16. A hair trimming unit according to claim 1, wherein the housing has end parts located beyond the opposite ends of the blade, the end parts having smoothly rounded profiles when viewed perpendicular to the contact surface.

17. A hair trimming unit according to claim 1, wherein the blade is adjustably mounted to the housing for varying the distance between the cutting edge and the contact surface.

18. A hair trimming unit according to claim 1, wherein the trimming unit is attached to a shaving cartridge of a safety razor.

19. A hair trimming unit according to claim 18, wherein the shaving cartridge has a blade housing with front and rear sides and the hair trimming unit is attached to the rear side.

20. A hair trimming unit according to claim 1, wherein the hair trimming unit is carried on an elongate handle having an axis in a plane perpendicular to the length of the blade edge.
